(19) United States
(12) Patent Application Publication
(10) Pub. No.: US 2009/0119996 A1
(43) Pub. Date: May 14, 2009

(54) Power transmitting system for rotary wings of automatic revolving door

(76) Inventor: Bok Kwon Wang, Gyeonggi-do (KR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/989,660

(22) PCT Filed: May 24, 2006
(86) PCT No.: PCT/KR2006/001956

§ 371 Date: Jan. 29, 2008

(30) Foreign Application Priority Data
Jul. 29, 2005 (KR) 10-2005-0069370

(51) Int. Cl. E05D 15/02

(52) U.S. Cl. 49/42

(57) ABSTRACT

A revolving driving force structure of a revolving wing for an automatic revolving door is provided, in which a revolving door of an automatic revolving door having an inner body with a revolving door at an inner side of an outer body provided at a front end of a transparent wall member is generated based on a rotation roller protruded from the inner body and by an operation motor which rotates the rotation door, and the rotation roller is supported on an inner support protrusion, and it is possible to prevent any safety accident based on a stable rotation of the inner body and the revolving wing and a constant gap during the rotation of the revolving wing, and a simple structure can be obtained, and a durability and life span increase without any load.

### TECHNICAL FIELD

The present invention relates to a revolving driving force structure of a revolving wing for an automatic revolving door installed at an entrance of each building, and in particular to a revolving driving force structure of a revolving wing for an automatic revolving door in which a revolving door of an automatic revolving door having an inner body with a revolving door at an inner side of an outer body provided at a front end of a transparent wall member is generated based on a rotation roller protruded from the inner body and by an operation motor which rotates the rotation door, and the rotation roller is supported on an inner support protrusion, and it is possible to prevent any safety accident based on a stable rotation of the inner body and the revolving wing and a constant gap during the rotation of the revolving wing, and a simple structure can be obtained, and a durability and life span increase without any load.

### BACKGROUND ART

Generally, a revolving door is installed at an entrance of a building, while passenger and various things passing through the revolving door.

With the above construction, a person who wants to pass the revolving door pushes the revolving wing so as to rotate the rotary shaft, so that the person can pass through the revolving door.

Recently, there is provided a driving apparatus at the rotary shaft, and a detection sensor is installed at the entrance part. When a person comes near, the detection sensor detects, and power is applied to the driving force apparatus, and the rotary shaft connected with the same automatically rotates, so that the person can push the revolving door.

In particular, the conventional revolving door and automatic revolving door have problems that a thing or part of clothes may be caught by the end of the revolving wing or the inner surface of the transparent wall member. In case that a long thing is intended to pass the door, it is impossible to pass the door due to the formation angle of the revolving wing.

Recently, a certain structure, in which each revolving wing is rotated and folded in one direction or both directions from the rotary shaft, has been developed. When a certain safety accident occurs, it is possible to quickly fold a corresponding revolving wing for thereby taking a proper measurement. When allowing a long thing to pass, a corresponding revolving wing is folded from the rotary shaft to one side, so that a passage is obtained.

However, the folding structure of the automatic revolving door and revolving wing is designed to be folded with respect to the center rotary shaft. Even when the revolving wing is folded, since the revolving wing and the center rotary shaft still remain at the center of the revolving door, it is impossible to obtain a wider passage.

Namely, since the conventional revolving door or automatic revolving door has a number of revolving wings at the vertical center rotary shaft, in the case that the revolving wings are needed to be folded for obtaining a desired passage or for the reason of safety, the revolving wing is folded from the center rotary shaft. Therefore, since the center rotary shaft and revolving wing still remain at the inner center of the revolving door, it is impossible to obtain a desire wider passage.

In case of a VIP or entertainment star who needs body guards, since he should pass the revolving door alone, a security problem occurs since his body is exposed without security. In addition, in a place where exhibits a large thing like in a vehicle exhibition place or a furniture exhibition place, it is impossible to pass the thing through the revolving door having a center revolving shaft, so that it is needed to install an additional entrance path or a large size closing and opening door.

Therefore, according to the Korean patent application No. 69334 of 2005 developed by the applicant of the present invention, each revolving wing divided at a certain angle is hinged at the lower side of the upper plate revolving from the driving motor, with an upper outer portion of the revolving wing being hinged at the outer end of the inner support member of the upper plate, and with the inner side of the upper end of the revolving wing being slide-engaged at the lower side of the crossbar, so that that each revolving wing is unfolded toward the outer wall body with respect to the front end.

In a state that there is not a center rotary shaft, it can fully satisfy the inherent function of the revolving door like the conventional art. When the passage of the revolving door is opened, the revolving wing is folded and unfolded inwards of the wall member, so that the revolving door is fully opened. With this construction, the VIP or entertainment star who needs high security can pass the door with body guards. In addition, a large size thing such as a vehicle or furniture can pass without an additional closing and opening door. So, various things can pass without disturbing passage and it is possible to provide a passage through which a number of persons can pass at one time. An automatic revolving door having a dispersion folding structure of a revolving wing having the maximized efficiency can achieved.

However, since the above revolving structure of the automatic revolving door is largely dependent on the driving force of the driving motor installed at the front end of the outer body, over driving force is needed. A support force of the inner body is unstable, and movements may occur at the inner body and the revolving wing.

The gaps between the inner side of the transparent wall member and the end of the revolving wing should be constant, so that it is possible to prevent part of clothes or thing from being caught. However, in the above conventional art, the gaps are not constant or may be changed, so that there are many problems.

The relatively heavier revolving wings and inner body are fixed based on the driving force shaft provided at the upper center of the outer body and the fixing circular plate adapted to fix the same, so that the durability is so bad. Over load is applied, so that the life span decreases.

### DISCLOSURE OF INVENTION

Accordingly, it is an object of the present invention to overcome the problems encountered in the conventional art.

It is another object of the present invention to provide a rotation driving force structure of a revolving wing for an automatic revolving door having a dispersion unfolding structure in which a protrusion is formed at an inner side of an outer body of an automatic revolving door, and a plurality of rotation rollers engaged at an outer surface of the inner body are supported by the protrusion, and a driving force is applied to from the rotation motor engaged at an inner side of the inner body to one of the rotation rollers, so that the rotation roller operates a role of the driving roller so that the rotation roller rotates the inner body and the revolving wing. With this construction, a structural stability is enhanced by directly supporting the heavy inner body and revolving wing to the outer body, and the distance between the inner and outer bodies is made instant based on the guide shaft formed at an intermediate portion between the inner and outer bodies for thereby preventing safety problems, and a light and compact sized rotation motor is engaged at the inner side of the inner body and is rotated together with the inner body, so that the driving mean is simplified, and the vertical support force is enhanced using the rotation roller, and it is possible to transfer good rotational force.

### BRIEF DESCRIPTION OF THE DRAWINGS

FIG. 1 is a perspective view illustrating an automatic revolving door having a revolving driving force structure according to the present invention;

FIG. 2 is a side cross sectional view illustrating an automatic revolving door according to the present invention;

FIG. 3 is a plane view illustrating an automatic revolving door according to the present invention;

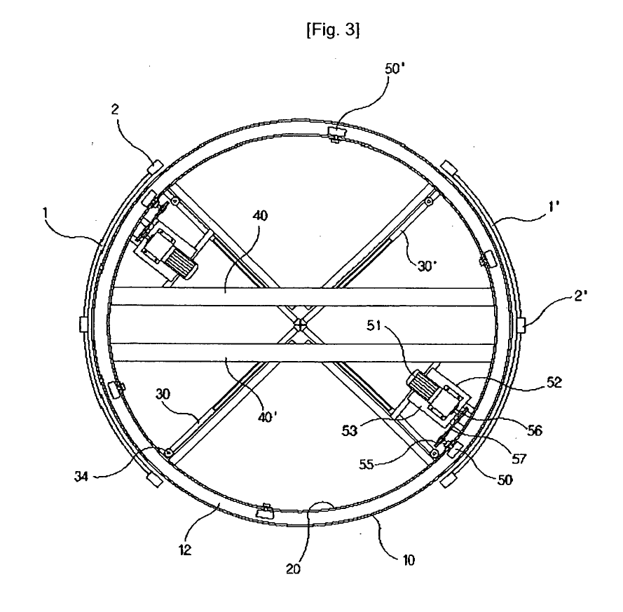

FIG. 4 is a separated perspective view illustrating an automatic revolving door according to the present invention; and

FIG. 5 is a cross sectional view of an enlarged major part of an automatic revolving door according to the present invention.

### BEST MODE FOR CARRYING OUT THE INVENTION

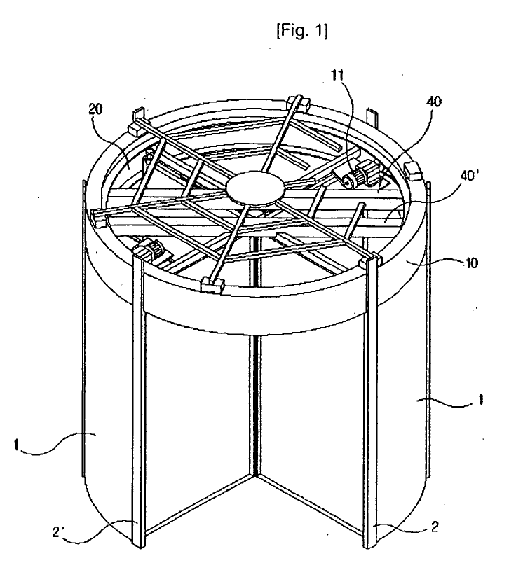

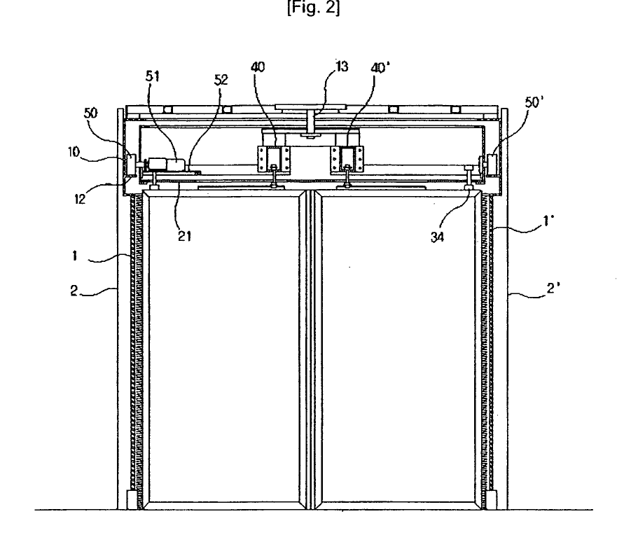

FIG. 1 is a perspective view illustrating an automatic revolving door having a revolving driving force structure according to the present invention, and FIG. 2 is a side cross sectional view illustrating an automatic revolving door according to the present invention.

In an automatic folding structure of a revolving wing for an automatic revolving door in which an inner body 20 having an upper plate 21 at a lower side of the same is provided at an inner side of an outer body 10 formed at an upper side of vertical frames 2 and 2′ having transparent wall members 1 and 1′, and a plurality of divided revolving wings 30 and 30′ are provided at the lower side of the upper plate 21, so that the inner body 20 and the revolving wings 30 and 30′ rotate together, and the revolving wings 30 and 30′ are fully unfolded in the direction of the transparent wall members 1 and 1′ along the crossbars 40 and 40′ with respect to a hinge shaft 34 of one upper side, there is provided an improved rotation driving force structure of a revolving wing for an automatic revolving door characterized in that a support protrusion 12 is protruded from an inner side of the outer body 10, and a plurality of rotation rollers 50 and 50′ are protruded from an outer surface of the inner body 20, and the rotation rollers 50 and 50′ are supported by the support protrusion 12, and an additional shaft 13 suspended from the center to the lower side of the outer body 10 is fixed at the center of the inner body 20, with the lower end of the same being rotatable, and an operation motor 51 is connected with a plurality of radial rotation rollers 50 and 50′, and the rotation rollers 50 and 50′ rotate by the operation motor 51, and the inner body 20 and the revolving wings 30 and 30′ rotate with respect to the guide shaft 13.

The operation motor 51 is formed opposite to both inner sides of the inner body 20, and each operation motor 51 is supported by the engaging plate 53 on the support member 52 which is horizontally formed at the inner side of the inner body 20, and the rotation rollers 50 and 50′ are provided with a rotation pulley 55 at the end of the same so that the rotary shaft 54 is protruded in the inner direction of the inner body 20, and the operation pulley 56 of the operation motor 51 is connected with the rotation pulley 55 of the rotation rollers 50 and 50′ through a driving belt 57.

The operation of the rotation force structure of the revolving wing for an automatic revolving door having a dispersion unfolding structure according to the present invention will be described with reference to the accompanying drawings.

As shown therein, a basic structure is formed in such a manner that there are provided vertical frames 2 and 2′ in a building at regular intervals, and transparent wall members 1 and 1′ provided between vertical frames 2 and 2′. An entrance is provided at both sides of the vertical frames 2 and 2′. The transparent wall members 1 and 1′ are not formed at the entrance.

Here, the transparent wall members 1 and 1′ are preferably formed of tempered glass or high strength synthetic resin.

The outer body 10 is provided at the upper sides of the transparent members 1 and 1′ and the vertical frames 2 and 2′ and includes various driving parts and operation parts therein. The inner body 20 is provided at the inner side of the outer body 10 and rotates together with the revolving wings 30 and 30′.

The inner body 20 rotates together with the revolving wings 30 and 30′ at the inner side of the outer body 10 based on rotational force received from the inner operation motor 51.

The inner body 20 provided at the inner side of the outer body 10 is fixed by the guide shaft 13 suspended from the center of the outer body 10 to the lower side. The guide shaft 13 is provided so as to prevent the centers of the outer body 10 and the inner body 20 from being deviated from each other. In addition, with the above construction, the gaps between the ends of the revolving wings 30 and 30′ and the inner wall of the transparent wall members 1 and 1′ maintain constantly during the rotation of the revolving wings 30 and 30′ of the lower side.

The inner body 20 is supported by the rotation rollers 50 and 50′ on the support protrusion 12 protruded from the inner side of the outer body 10. The rotation rollers 50 and 50′ are protruded from the outer surface of the inner body 20 in the radial direction. The rotation rollers 50 and 50′ are supported by the support protrusion 12 of the outer body 10 for thereby supporting the inner body 20.

Therefore, the inner body 20 rotates along the support protrusion 12 and minimizes the rotational friction.

In particular, in the present invention, the inner body 20 is rotated by providing a certain driving force member at part of the rotation rollers 50 and 50′ as compared to the conventional art in which the driving motor is additionally provided so as to drive the inner body 20, so that the inner body 20 and the revolving wings 30 and 30′ are concurrently rotated by the rotational force of the rotation rollers 50 and 50′.

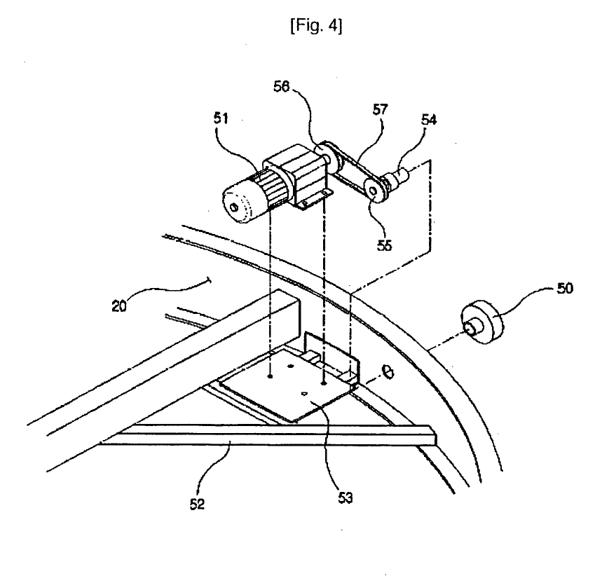

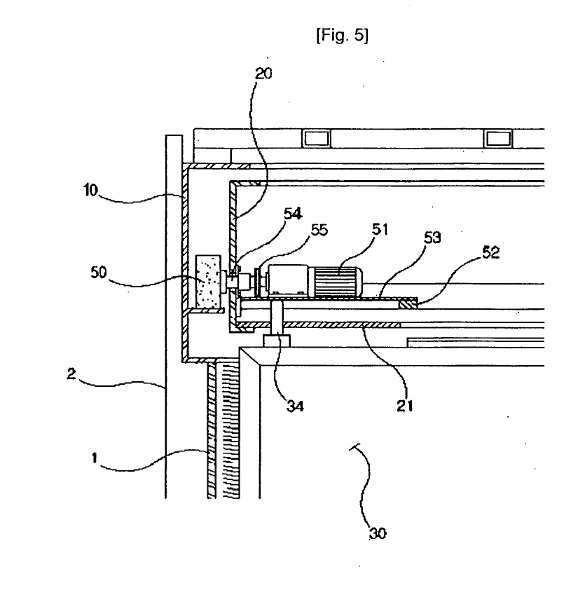

As shown in FIGS. 4 and 5, the rotary shaft 54 of the rotation rollers 50 and 50′ is protruded inwards of the inner body 20 and is engaged with the rotation pulley 55. A plurality of mounting members 52 are provided at the inner side of the inner body 20 in a horizontal shape. An operation motor 52 is provided at the mounting plate 53 of the upper side.

When the operation pulley 56 of the operation motor 51 is connected with the rotation pulley 55 of the rotation rollers 50 and 50′ using a driving belt 57, the rotation pulley 55 and the rotation rollers 50 and 50′ rotate based on the operation of the operation motor 51, so that the inner body 20 rotates along the support protrusion 12 of the outer body 10.

The inner body 20 rotates, the revolving wings 30 and 30′ of the lower side rotate together, so that the operation structure of the automatic revolving door is obtained. Preferably, the construction of the operation motor 51 is divided at both inner ends of the inner body 20 for a uniform distribution of the rotational force. In some cases, the inner body 20 and the revolving wings 30 and 30′ may be rotated by the operation motors 51 which have 3-divide angles or 4-divided angles.

In the present invention, it is possible to achieve an effective driving force transfer mechanism with simple construction in the driving force structure of the automatic revolving door. Namely, the driving force structure of the automatic revolving door can be performed in such a manner that the revolving wings are fully unfolded toward the transparent wall body based on the rotation operation of the inner body.

Since a stable operation is obtained, and the gap generated during the rotation is uniform, it is possible to prevent safety accident, and durability is enhanced, and life span is largely extended.

### INDUSTRIAL APPLICABILITY

As described above, in the rotation driving force structure of a revolving wing for an automatic revolving door having a dispersion unfolding structure according to the present invention, the heavier inner body and revolving wing are directly supported by the outer body for thereby obtaining a structural stability. The intervals between the inner and outer bodies are constant based on the guide shaft formed at the intermediate portion of the inner and outer bodies for thereby preventing a safety accident.

The light and compact sized rotation motor is directly engaged at the inner side of the inner body and is rotated together with the inner body, so that the driving means is simplified, and the vertical support force is enhanced based on the rotation rollers. The rotation friction force decreases, and good rotational forcer is transferred.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An automatic folding structure of a revolving wing for an automatic revolving door in which an inner body 20 having an upper plate 21 at a lower side of the same is provided at an inner side of an outer body 10 formed at an upper side of vertical frames 2 and 2′ having transparent wall members 1 and 1′, and a plurality of divided revolving wings 30 and 30′ are provided at the lower side of the upper plate 21, so that the inner body 20 and the revolving wings 30 and 30′ rotate together, and the revolving wings 30 and 30′ are fully unfolded in the direction of the transparent wall members 1 and 1′ along the crossbars 40 and 40′ with respect to a hinge shaft 34 of one upper side, an improved rotation driving force structure of a revolving wing for an automatic revolving door characterized in that a support protrusion 12 is protruded from an inner side of the outer body 10, and a plurality of rotation rollers 50 and 50′ are protruded from an outer surface of the inner body 20, and the rotation rollers 50 and 50′ are supported by the support protrusion 12, and an additional shaft 13 suspended from the center to the lower side of the outer body 10 is fixed at the center of the inner body 20, with the lower end of the same being rotatable, and an operation motor 51 is connected with a plurality of radial rotation rollers 50 and 50′, and the rotation rollers 50 and 50′ rotate by the operation motor 51, and the inner body 20 and the revolving wings 30 and 30′ rotate with respect to the guide shaft 13.

2. The structure of claim 1, wherein the operation motor 51 is formed opposite to both inner sides of the inner body 20, and each operation motor 51 is supported by the engaging plate 53 on the support member 52 which is horizontally formed at the inner side of the inner body 20, and the rotation rollers 50 and 50′ are provided with a rotation pulley 55 at the end of the same so that the rotary shaft 54 is protruded in the inner direction of the inner body 20, and the operation pulley 56 of the operation motor 51 is connected with the rotation pulley 55 of the rotation rollers 50 and 50′ through a driving belt 57.
